(19) United States
(12) Patent Application Publication
(10) Pub. No.: US 2024/0227736 A1
(43) Pub. Date: Jul. 11, 2024

(54) ADAPTER FOR A WIPING SYSTEM

(71) Applicant: Valeo Systèmes d'Essuyage, Le Mesnil Saint Denis (FR)

(72) Inventors: Vincent Gaucher, Le Mesnil Saint Denis (FR); Stéphane Houssat, Le Mesnil Saint Denis (FR); Eric Poton, Le Mesnil Saint Denis (FR); Olivier Jomard, Le Mesnil Saint Denis (FR)

(73) Assignee: Valeo Systèmes d'Essuyage, Le Mesnil Saint Denis (FR)

(21) Appl. No.: 18/558,862

(22) PCT Filed: Apr. 22, 2022
(86) PCT No.: PCT/EP2022/060770

§ 371 Date: Nov. 3, 2023

(30) Foreign Application Priority Data
May 4, 2021 (FR) FR2104721

(51) Int. Cl. B60S 1/40

(52) U.S. Cl. CPC B60S 1/4048; B60S 2001/4051

(57) ABSTRACT

The invention relates to an adapter (6) for attaching a wiper blade to an arm of a wiping system, the adapter (6) having a longitudinal main direction of extension and being configured to be mounted such that it is pivotable about an axis of rotation on a connector of the wiper blade, the adapter (6) comprising at least one elastically deformable tab (48) supporting a locking member (56) intended to lock the adapter (6) with respect to the arm, the adapter also comprising at least one member (60) for limiting the displacement of the elastically deformable tab (48).

The field of the present invention is that of wiping systems designed for motor vehicles. More particularly, the field of the present invention is that of connection means implemented between a wiper arm and a wiper of such a wiping system.

At present, motor vehicles are equipped with wiping systems which are designed to clean their glazed surfaces, and in particular their windshield. Such wiping systems comprise at least one wiper arm and a wiper driven by the wiper arm. The wiper arm is connected to an electric motor of the vehicle, and the wiper comprises at least one wiper blade which is designed to come into contact with the glazed surface to be wiped. In order to be able to drive the wiper, an adapter is arranged between this wiper and the wiper arm. More particularly, the adapter is arranged between the wiper arm and a connector which is connected to the wiper.

The adapter is thus integral with the wiper arm, and more particularly with a cover of the wiper arm. Cooperation of this type between the adapter and the cover is removable, such that it makes it possible to change the wiper arm when it is worn.

Means are known which permit the removability and securing of the adapter relative to the cover of the arm, such as blocking units which are supported by the adapter, and can cooperate with complementary means which are supported by the cover. Blocking units of this type thus make it possible to block the position of the adapter relative to the wiper arm. In order to release the adapter from the cover, it is known for these blocking units to be supported by resiliently deformable tongues which make it possible to separate the blocking units from the cover, and thus the adapter from the cover.

A problem with these blocking units which are supported by the deformable tongues consists in the fact that the pressure which is exerted on said tongues in order to release the blocking units from the complementary means supported by the cover gives rise to substantial deformation of said tongues. When it is substantial, deformation of this type of the tongues can give rise to problems of deterioration of the resilience of the tongues, such that they cannot adopt their non-deformed state once more. Thus, in tongues of this type, the resilience of which has deteriorated, the capacity of said tongues to render the wiper integral with the wiper arm decreases, in particular when the wiping system is used at high speed.

The objective of the present invention is thus to improve the locking between the adapter and the cover of the wiper arm, by decreasing the risks of losses of resilience of the tongues further to excessive deformation of said tongues.

The invention thus relates to an adapter for securing a wiper on an arm of a wiping system, the adapter having a longitudinal direction, and being configured to be fitted such as to pivot around an axis of rotation on a connector of the wiper, the adapter comprising at least two lateral walls which are opposite one another in a transverse direction of the adapter, and are connected to one another by an upper wall, such that said lateral walls and the upper wall form a body of the adapter which delimits at least partly a receipt space for the connector, the upper wall being extended longitudinally by at least one lug, from which there extends at least one resiliently deformable tongue supporting a blocking unit which is designed to lock the adapter relative to the arm, said adapter being characterized in that it comprises at least one unit for limitation of the displacement of the resiliently deformable tongue, the limitation unit extending between the body of the adapter and the blocking unit.

The wiper and the arm form part of a wiping system of a vehicle, which system is designed to clean at least partly a glazed surface of said vehicle. The adapter, which extends in the longitudinal direction, parallel a the main direction of extension, is thus fitted such as to pivot relative to the connector, such that the wiper, and in particular a blade which it supports, follows a curve of the glazed surface.

The blocking unit makes it possible to block the adapter relative to the arm, and in particular relative to a cover which is provided at a longitudinal end of the arm.

The blocking unit can thus for example take the form of a blocking stud or button which projects from the tongue, and can cooperate with a complementary means formed in or on the cover of the wiper arm. The means complementary with the blocking unit of the adapter can for example be a blocking opening formed through the cover of the wiper arm.

The tongue comprises at least one bar and the blocking unit. More specifically, the bar of the tongue extends from the free edge of the lug, and is extended by the blocking unit. “Resiliently deformable tongue” means the fact that the tongue can be deformed then returned to an initial position before deformation without breakage of its material. A characteristic of this type of the tongue thus makes it possible to facilitate the insertion of the adapter in the cover of the arm, while permitting the insertion of the blocking unit in the blocking opening of the cover of the wiper arm, when the tongue regains its initial position.

The limitation unit thus makes it possible to limit and accompany the deformation of the tongue during the insertion of the adapter in the cover of the arm. This therefore limits the risks of breakage of the tongue during its deformation. It can also be noted that the limitation unit participates in the return of the tongue to its initial position.

It is also understood that certain parts of the adapter, such as the body, have a thickness such that they assure the rigidity of said body, whereas other parts, such as the tongue and the limitation unit, have a thickness such that they permit resilient deformation thereof.

According to a characteristic of the invention, the at least one limitation unit projects from an outer face of the lateral wall of the body.

The outer face of the lateral wall is opposite the receipt space of the adapter in the transverse direction thereof.

According to a characteristic of the invention, the limitation unit projects from the lateral wall at the level of the upper wall.

A longitudinal and transverse plane is defined which passes through the adapter, and such that it separates the lateral walls of the adapter into two portions, with said portions each having a dimension in a vertical direction, perpendicular to the longitudinal and transverse directions of the adapter, which are identical to one another. A first portion of the lateral walls thus corresponds to a portion from which the upper wall extends, and a second portion of the lateral walls corresponds to the portion which comprises a free edge of each of the lateral walls. Thus, the limitation unit projects from the first portion of the lateral wall of the adapter.

According to a characteristic of the invention, the at least one limitation unit projects from the lateral wall while going away from the upper wall.

It is understood that the limitation unit extends from the first portion of the lateral wall of the adapter from which the upper wall extends, towards the second portion of the lateral wall. Since the second portion of the lateral wall is the portion furthest away from the upper wall relative to the first portion, it is understood that the limitation unit extends going away from said upper wall.

According to a characteristic of the invention, the at least one limitation unit extends in a direction which intersects a plane on which the lateral wall is inscribed.

In addition, the at least one limitation unit extends in a direction which intersects a plane on which the upper wall is inscribed. More specifically, the upper wall is inscribed on a longitudinal and transverse plane, with the limitation unit extending in at least one direction which intersects said plane of the upper wall.

It is thus understood that the further the limitation unit goes away from the lateral wall, the more a distance between the unit and the lateral wall increases, taken in the transverse direction of the adapter.

According to a characteristic of the invention, the limitation unit comprises at least two parts which form a non-zero angle relative to one another.

According to an example of the invention, the limitation unit comprises a first part which extends substantially perpendicularly from the lateral wall, with the first part being extended by a second part, such that an angle of between 90° and 170° is formed between the first part and the second part.

According to a characteristic of the invention, the limitation unit has a thickness, taken in the transverse direction of the adapter, such that it provides said limitation unit both with a deformation capacity, and a capacity for resistance against the deformation of the tongue. It is understood from this characteristic that the limitation unit assures the accompaniment of the deformation of the tongue, while being itself resiliently deformable. In addition, the thickness of the limitation unit makes it possible to assure a force which opposes the force of deformation of the tongue, thus making it possible to limit said deformation.

According to a characteristic of the invention, the limitation unit comprises at least one securing end which is integral with the body of the adapter, and one connection end which is integral with the tongue.

More particularly, the securing end is the end of the limitation unit which is integral with the lateral wall of the adapter. The securing end and the connection end are opposite one another in the vertical direction of the adapter. It is also understood, and in particular from the inclination of the limitation unit relative to the plane of the lateral wall, that the connection end is further away from the lateral wall than the securing end, in the transverse direction.

It is also understood, from the structure of the tongue comprising the bar extended by the blocking unit, that the connection end of the limitation unit is integral with said blocking unit.

According to a characteristic of the invention, at least the body of the adapter, the lug, the tongue and the limitation unit, are obtained from the same material, and form an assembly in a single piece. “In a single piece” means the fact that the body of the adapter, the lug, the tongue and the limitation unit are inseparable without destroying one or the other of the elements listed.

According to a characteristic of the invention, the adapter comprises a head opposite the lug relative to the body, with the tongue extending from a free edge of the lug, and longitudinally in the direction of the head, with said tongue extending at least partly on one side of the body of the adapter in the transverse direction.

More particularly, the tongue extends at least in line with the limitation unit which projects from the lateral wall in the transverse direction. This therefore allows the blocking unit which extends the bar of the tongue to be integral with the limitation unit at its connection end.

According to a characteristic of the invention, the tongue comprises at least one grasping area positioned on the blocking unit, with the area for grasping of the tongue comprising at least one guide element which extends in the longitudinal direction of the adapter.

The grasping area makes it possible to facilitate pressure which the user applies to the tongue in order to release the wiper from the arm. More particularly, the grasping area forms a flat surface along a longitudinal and vertical plane of the adapter. It is thus understood that the grasping area corresponds to the portion of the tongue against which the force is generated in order to deform the tongue, and that its particular position at the connection end of the limitation unit makes it possible to limit the deformation of said tongue, thus preventing deformations beyond the resilient domain of the material which constitutes the tongue.

The guide element projects from the grasping area in the transverse direction of the adapter, and opposite the lug of said adapter.

According to a characteristic of the invention, the guide element comprises a guide surface which is configured to translate along a cover of the arm of the wiping system.

Advantageously, the guide element comprises a guide surface which is configured to translate longitudinally along the cover of the arm of the wiping system.

It is understood that, when the adapter is inserted in the cover of the arm, the guide element makes it possible to guide said insertion, in order to facilitate the cooperation between the unit for blocking of the adapter and the opening for blocking of the cover. This therefore facilitates the securing of the adapter in the cover for the user of the wiping system. The guide surface is a guide for the adapter in relation to the cover of the arm.

According to a characteristic of the invention, the head projects transversely and longitudinally from the body of the adapter, with the head comprising studs which extend along lateral walls in the direction of the tongue.

The studs of the adapter head are configured to cooperate with apertures formed in the cover. More specifically, the cover comprises at least two lateral flanks which extend on a longitudinal vertical plane, and in which the apertures are formed, such that they cooperate with the studs of the adapter head. It is understood that there is complementarity of forms between the studs and the apertures, such that they are imbricated in one another, thus blocking any vertical movement between the adapter and the cover.

In addition, it is understood that the guide surface of the guide element makes it possible to facilitate the cooperation between the studs and the apertures during insertion of the adapter in the cover, by guiding said insertion.

The invention also relates to a wiper comprising at least one wiper blade, a connector and an adapter according to any one of the preceding characteristics, with the blade being supported directly or indirectly by the connector, and the adapter being fitted such as to pivot relative to the connector.

According to an example of the invention, the blade of the wiper is supported indirectly by the connector, in particular by an elongate support made of synthetic and/or metal material, or by one or a plurality of vertebrae accommodated in the wiper blade.

The invention also relates to a wiping system for a motor vehicle, which comprises a wiper according to the preceding characteristic, and an arm which is connected to the wiper by translation of the adapter in a cover of the arm.

Other characteristics, details and advantages of the invention will become more clearly apparent from reading the description provided hereinafter by way of indication in relation with drawings in which:

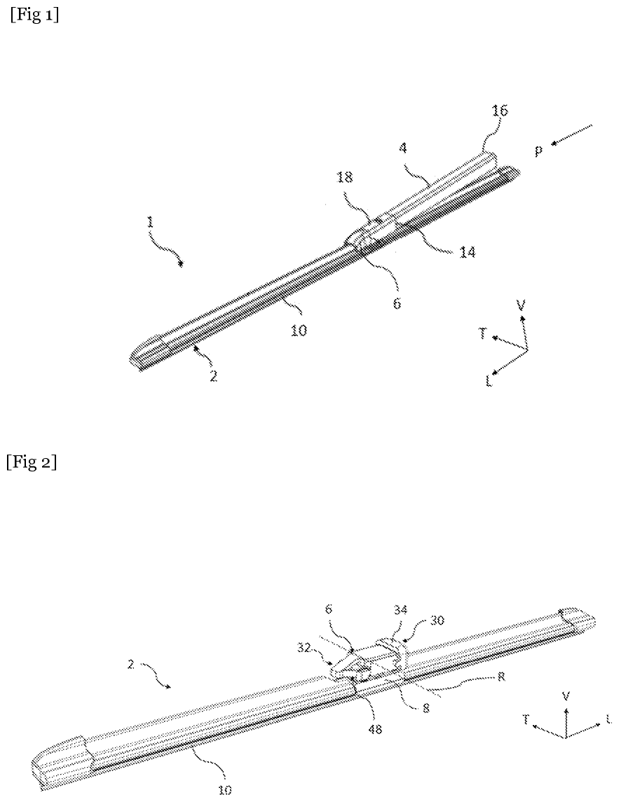

FIG. 1 is a general view in perspective of a wiping system according to the invention, comprising at least one wiper, an arm and an adapter;

FIG. 2 is a view in perspective of the adapter of [FIG. 1] coupled to a connector of the wiper of [FIG. 1];

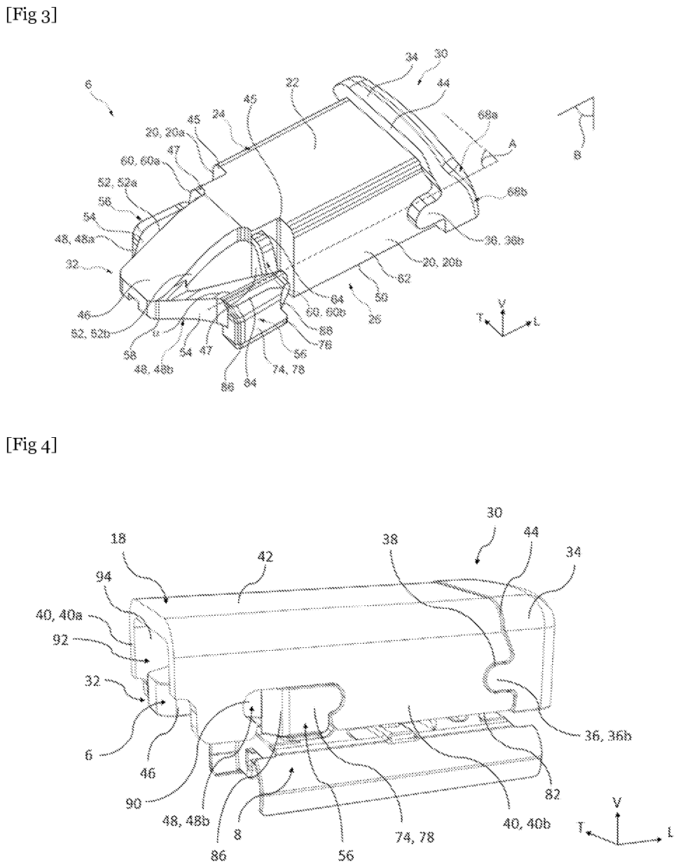

FIG. 3 is a view in perspective of the adapter of [FIG. 1], showing at least one limitation unit and at least one lug from which there extends at least one tongue bearing a blocking unit;

FIG. 4 is a view in perspective of the adapter of [FIG. 1] integral with a cover of the arm of the wiping system of [FIG. 1];

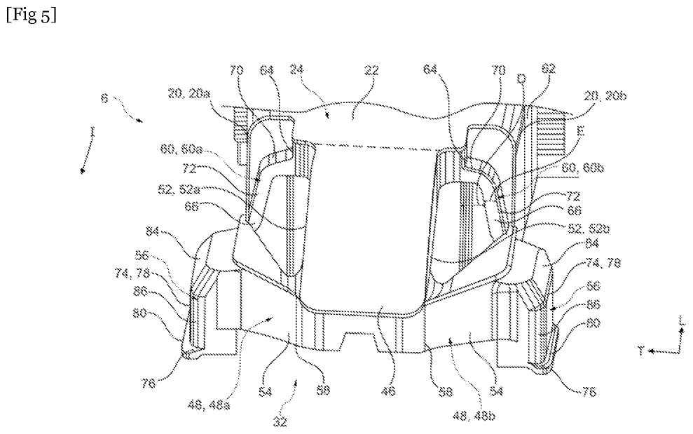

FIG. 5 is a close-up view of at least one tongue and at least one unit for limitation of the adapter of [FIG. 1].

It should first of all be noted that, while the figures set out the invention in detail for the implementation thereof, and it will be appreciated that these figures may be used to define the invention better, where appropriate. It should also be noted that these figures merely show embodiments of the invention. Lastly, the same references denote the same elements throughout the figures.

FIG. 1 illustrates a wiping system 1 according to the invention. As represented, this wiping system 1 comprises at least one wiper 2 and at least one arm 4 which are connected to one another by at least one adapter 6 according to the invention. More specifically, the adapter 6 makes it possible to connect a connector 8, shown in [FIG. 2] which bears the wiper 2, the wiper comprising a blade 10, to the wiper arm 4.

The blade 10 of the wiper 2 is designed to come into contact with a glazed surface of a vehicle, not shown, equipped with the wiping system 1 according to the invention. According to an example of the invention, the wiper 2 can comprise at least one strengthening unit, for example an elongate support made of synthetic material and/or one or a plurality of metal vertebrae.

The wiper arm 4 for its part is configured to rotate the wiper 2. Thus, the arm 4 comprises at least a first end 14, which is rendered integral with the adapter 6, and a second end 16 opposite the first end 14, in a main direction of extension P of the arm 4, the second end 16 being integral with a drive motor, not shown, accommodated within the motor vehicle. More specifically, the first end 14 of the arm 4 bears a cover 18 which can cooperate with the adapter 6, in order to render said wiper 2 integral with the arm 4.

The adapter 6, shown in FIGS. 2 and 3, extends in a longitudinal main direction of extension L, parallel to the main direction of extension P of the arm 4, and comprises at least two lateral walls 20 opposite one another in a transverse direction T of the adapter 6, perpendicular to the longitudinal direction L. Each lateral wall 20 extends on a plane L, V of a trihedron L, V, T illustrated in each of the figures, with the vertical direction V being perpendicular to the longitudinal L and transverse T directions. The adapter 6 also comprises at least one upper wall 22 which extends mainly on a plane L, T of the adapter 6, and such that said upper wall 22 connects the lateral walls 20 of the adapter. The lateral walls 20, as well as the upper wall 22, delimit a receipt space 26 of the connector 8 at least partly.

The adapter 6 is fitted such as to pivot around an axis of rotation R on the connector 8 of the wiper 2, with the axis of rotation R shown in [FIG. 2] being parallel to the transverse direction T of the adapter 6. For this purpose, the adapter 6 comprises at least one means for rotation of the adapter 6 relative to the connector 8, which is formed on the lateral walls 20 of the adapter 6, and opens up or projects onto the receipt base of the connector 8. There is thus definition of a first lateral wall 20a, shown in [FIG. 3], which bears a cylindrical stud of the means for rotation, not shown, projecting towards the receipt base 26, and a second lateral wall 20b, which bears a bearing, not shown. The bearing and the cylindrical stud are thus aligned along the axis of rotation R. The means for rotation can be formed exclusively by the bearing, but it can also be formed by a combination of the bearing and the cylindrical stud.

A front end 30 and a rear end 32 of the adapter 6 are defined, opposite one another in the longitudinal direction L of the adapter 6. The front end 30 of the adapter 6 corresponds to the longitudinal end of the adapter 6 which bears a head 34 of the adapter 6, extending substantially on a plane V, T. More specifically, and as shown in [FIG. 3], the head 34 projects transversely and longitudinally from the lateral walls 20 and from the upper wall 22 of the adapter 6, and participates at least partly in closing longitudinally the receipt space 26 of the connector 8 at the front end 30 of the adapter 6. The head 34 also comprises studs 36 which extend along the lateral walls 20 of the adapter 6, towards its rear end 32, and in the longitudinal direction L of the adapter 6. More specifically, a first stud, not shown, extends along the first lateral wall 20a of the adapter, and a second stud 36b extends along the second lateral wall 20b of the adapter 6, each stud being positioned equidistantly between an outer face of the upper wall 22 and a free edge 50 of each lateral wall 20a, 20b.

Each of the studs 36 is thus configured to cooperate with apertures 38 formed in lateral flanks 40 of the cover 18 of the wiper arm 4, as shown in [FIG. 4]. More particularly, the cover 18 of the wiper arm 4 comprises at least one first lateral flank 40a and one second lateral flank 40b which each extend on a plane L, V, and are connected to one another by an upper flank 42 which extends on a plane L, T.

Each of the first lateral flank 40a and the second lateral flank 40b thus comprises respectively a first aperture, not shown, and a second aperture 38, said apertures 38 being formed such that they cooperate respectively with the first stud and the second stud 36b of the adapter. It is thus understood that the studs 36 and the apertures 38 have complementarity of forms, in order to cooperate with one another, and thus block the adapter vertically relative to an open end of the cover.

This longitudinal, open end of the cover 18 which contains the apertures 38 is positioned in contact with a shoulder 44 of the head 34, which extends transversely and longitudinally beyond the body 24 of the adapter 6. In other words, the lateral flanks 40 and the upper flank 42 are positioned in contact with the shoulder 44 of the head 34 at the longitudinal open end of the cover 18. It is thus understood that the head 34, and in particular its shoulder 44, forms a longitudinal stop during the insertion of the adapter 6 in the cover 18, by longitudinal translation from the rear end 32 as far as the front end 30 of the adapter 6.

At least one of the lateral walls 20 of the adapter 6 also comprises at least one relief 45 formed opposite the head 34 of the adapter 6 in the longitudinal direction L thereof. More specifically, the relief 45 is formed such that it extends according to the plane T, V, and on the plane L, V at a longitudinal end 47 of the lateral wall 20 which is opposite the head 34 of the adapter 6. It should be noted that at least one lateral wall comprises a relief 45. Advantageously, each of the two lateral walls comprises its own relief, as described above.

In addition, and as can be seen in particular in [FIG. 3], the upper wall 22 extends longitudinally and transversely, such that it connects each of the reliefs of the first lateral wall 20a and the second lateral wall 20b. Thus, the lateral walls 20, in which the relief 45 is formed, and the upper wall 22, form a body 24 of the adapter 6 which delimits the receipt space 26 of the connector 8 at least partly.

The rear end 32 of the adapter 6, shown in [FIG. 3], corresponds to the end of said adapter 6 which supports a lug 46 from which at least one resiliently deformable tongue 48 extends. More particularly, the lug 46 extends longitudinally from the upper wall 22 of the body 24 of the adapter 6, opposite the head 34. In addition, the lug 46 extends on a plane which is inclined relative to a main plane L, T on which the upper wall 22 extends, and such that said lug 46 is spaced from said upper wall 22 while being contained between the main plane L, T of the upper wall 22, and a plane L, T which comprises free edges 50 of the lateral walls 20.

According to the example of the invention illustrated, a first tongue 48a extends from a first free edge 52a of the lug 46, and a second tongue 48b extends from a second free edge 52b of the lug 46, opposite the first free edge 52a, in a direction with an angle which is non-zero relative to a plane L, V, and in the direction of the head 34. The tongues 48 thus have the function of locking the adapter 6 relative to the cover 18 of the arm 4, in particular by means of at least one blocking unit 56, which will be described hereinafter in the detailed description. As illustrated in [FIG. 3], the first tongue 48a extends longitudinally, and such that it is at least partly in line with the body 24 of the adapter 6, in its transverse direction T. More specifically, the first tongue 48a extends longitudinally such that it is at least partly in line with the relief 45 of the first lateral wall 20a in the transverse direction T of the adapter 6.

The first tongue 48a comprises a bar 54 and the blocking unit 56. More particularly, the bar 54 of the first tongue 48a extends from the first free edge 52a of the lug 46, with the area of rendering integral between the bar 54 of the first tongue 48a and the first free edge 52a of the lug 46 forming a hinge area 58. The bar 54, which is positioned opposite its hinge area 58, is thus extended longitudinally and transversely by the blocking unit 56 which is designed to lock the adapter 6 relative to the cover 18 of the arm 4. It is thus understood that the bar 54 and the blocking unit 56 extend relative to one another according to a first angle x of between 30° and 175°. The blocking unit 56 can for example be a blocking stud which projects from the first tongue 48a opposite the lug 46. It is also understood from the foregoing that at least part of the blocking unit 56 is in line with the relief 45 of the first lateral wall 20a of the adapter 6 in its transverse direction T.

As previously described, the first tongue 48a is resiliently deformable, such that it can be deformed, then returned to its initial state without its material breaking.

More specifically, the first tongue 48a is configured to be deformed in the transverse direction T of the adapter 6, towards the relief 45 of the first lateral wall 20, facing which the first tongue 48a extends at least partly. The deformation thus takes place mainly at the hinge area 58 of the first tongue 48a.

It should be considered that all of the characteristics described for the first tongue 48a apply mutatis mutandis when the adapter 6 comprises a single tongue, and also when the adapter 6 comprises a plurality of tongues. Thus, in the example illustrated, the characteristics of the first tongue 48a apply mutatis mutandis to the second tongue 48b.

According to the invention, the adapter 6 comprises at least one unit 60 for limitation of the displacement of one of the tongues 48, which is shown in particular in FIGS. 3 and 5, and extends between the body 24 of the adapter 6 and the blocking unit 56.

A first limitation unit 60a extends from the first lateral wall 20a and the blocking unit 56 of the first tongue 48a, and a second limitation unit 60b extends between the second lateral wall 20b and the blocking unit of the second tongue 48b. In addition, the first limitation unit 60a and/or the second limitation unit 60b project(s) from an outer face 62 which delimits the relief 45 respectively of the first lateral wall 20a or the second lateral wall 20b, said outer face 62 being opposite the space 26 for receipt of the adapter 6.

The first limitation unit 60a can for example be in the form of a blade, and comprises at least one securing end 64 which is integral with the first lateral wall 20a at its relief 45, and a connection end 66 which is integral with the first tongue 48a concerned, and more particularly with the blocking unit 56. The connection end 66 and the securing end 64 of the tongue 48 are opposite one another in the vertical direction V of the adapter 6. It is thus understood that the first tongue 48a is integral firstly with the free edge 52a of the lug 46, and secondly with the connection end 66 of the first limitation unit 60a.

A plane L, T known as plane A is defined, shown in [FIG. 3], which passes through the adapter 6 such that it divides the adapter into two adapter portions with identical vertical dimensions. A first portion of adapter 68a is thus identified, which comprises the upper wall 22, and a second portion of adapter 68b, which comprises the free edges 50 of the lateral walls 48. The first limitation unit 60a thus projects from the first lateral wall 20 at the first portion of adapter 68a, i.e. at the upper wall 22. More specifically, the first limitation unit 60a extends from the first lateral wall 20a and, going away from the upper wall 22, towards the free edge 50 of the lateral wall 20. In other words, the first limitation unit 60a extends from the first adapter portion 68a to the second adapter portion 68b.

In addition, and as shown in particular in [FIG. 5], the first limitation unit 60a extends in at least one direction I which intersects a plane B, shown in [FIG. 3], which is parallel to the plane L, V on which the lateral walls 20 are inscribed. More particularly, the first limitation unit 60a comprises a first part 70 which projects from the first lateral wall 20a, at its relief 45, and which comprises the securing end 64, with the first part 70 of the first limitation unit 60a extending substantially perpendicularly to the first lateral wall 20a. In addition, the first part 70 of the first limitation unit 60a is extended by a second part 72, which extends relative to the first part 70 according to a second angle of inclination of between 90° and 170°.

It is thus understood that a distance D taken along a straight line parallel to the transverse direction T of the adapter 6, between the first limitation unit 60a and the first lateral wall 20a from which it extends, increases from the securing end 64 as far as the connection end 66 of the first limitation unit 60a. In addition, it must be considered that, according to the invention, a thickness E of the first limitation unit 60a taken along a straight line parallel to the transverse direction T of the adapter 6, is determined such that it allows the first limitation unit 60a to be resiliently deformable, while assuring retention of the first tongue 48a during its deformation. In other words, the thickness E of the first limitation unit 60a allows the unit to be deformed, then return to its initial state before deformation.

It should be considered that the series of characteristics described for the first limitation unit 60a applies mutatis mutandis when the adapter 6 comprises a single limitation unit or a plurality of limitation units. Thus, in the example illustrated, the characteristics of the first limitation unit 60a apply mutatis mutandis to the second limitation unit 60b.

When a user wishes to separate the adapter according to the invention from the cover, pressure is exerted on at least one of the blocking units 56 in the transverse direction T of the adapter 6, and in the direction of each of the lateral walls 20.

Thus, at least one of the limitation units 60 is deformed such that the connection end 66 approaches the lateral wall 20. The limitation units 60 thus make it possible to accompany the deformation of the tongues 48, in particular while limiting their deformation. In fact, the structure of the limitation units 60 previously described, and in particular their thicknesses E, the material and/or their first parts 70 and second parts 72 which are inclined relative to one another, make it possible to generate a force of retention against the thrust force of the deformation of the tongues 48. This therefore limits the risk of irreversible deterioration of the tongues 48, and in particular the risk of breakage at each of the hinge areas 48 of the tongues 48, further to excessive deformation.

As shown in particular in [FIG. 3], at least one grasping area 74 is formed on one of the blocking units 56 of one of the tongues 48, with the grasping area 74 comprising at least one guide element 76 which extends in the longitudinal direction L of the adapter 6. More particularly, the grasping area 74 comprises a flat surface 78 which extends on a plane L, V, and makes it possible to facilitate the grasping of the tongue 48 by a user of the wiping system. The grasping area 74 is thus formed on one of the tongues 48, opposite the lug 46 of the adapter 6 in its transverse direction T. According to the example of the invention illustrated, the first tongue 48a and the second tongue 48b each comprise the grasping area 74 as described above.

The guide element 76, which is shown in particular in [FIG. 5], for one of the tongues 48, extends at a vertical end of the grasping area 74, with said guide element 76 extending along the grasping area 74 in the longitudinal direction L of the adapter 6. More specifically, the guide element 76 projects from the grasping area 74 in the transverse direction T, extending opposite one of the lateral walls 20 of the adapter 6. Thus, the guide element 76 comprises a guide surface 80 which is configured to translate longitudinally along the cover 18 of the arm of the wiping system. It is thus understood that the insertion of the adapter 6 is facilitated according to a movement of longitudinal translation, with a free edge 82 of each of the lateral flanks 40 of the cover, shown in [FIG. 4], being supported against the guide surface 80 of each of the guide elements 76. According to the example of the invention, each of the tongues 48 comprises the guide element 76 as it has just been described.

As shown in [FIG. 5], at least one of the blocking units 56 comprises at least one chamfered edge. More specifically, at least one of the blocking units 56 comprises an upper chamfer 84 formed at a vertical end of said blocking unit 56 opposite the guide element 76. In particular, the upper chamfer 84 extends in the longitudinal direction L of the adapter 6, for example over all of a longitudinal dimension of the grasping area 74.

In addition, and as shown in FIGS. 3 and 5, the at least one blocking unit 56 comprises a first lateral chamfer 86 and a second lateral chamfer 88, each positioned at a longitudinal end of the blocking unit 56. Each of the lateral chamfers 86, 88 thus extends substantially in the vertical direction V of the adapter 6, and over all of a vertical dimension of the blocking unit 56. According to the example of the invention, each of the blocking units 56 of each of the tongues 48 comprises the lateral chamfers 56, 88, and the upper chamfer 84.

It is thus understood that each of the lateral chamfers 86, 88 and the upper chamfer 84 of the blocking units 56 makes it possible to facilitate the translation of the adapter 6 during its insertion in the cover 18 of the wiper arm. In particular, the lateral chamfers 86, 88 make it possible firstly to limit the blocking of the longitudinal translation of the adapter 6 in the cover 18, and secondly to accompany the passage of the tongues 48 from their deformed state to their initial state upon completion of the assembly, and vice versa. This therefore makes it possible to limit the risks of deterioration of the material of the tongue.

According to a characteristic of the invention shown in [FIG. 3], each of the tongues 48, and in particular each of the blocking units 56, extends transversely beyond the planes L, V on which the lateral walls 20 of the adapter 6 extend. A characteristic of this type in particular allows the blocking units 56 to be accommodated in blocking openings 90 of the cover 18, shown in [FIG. 4], during the assembly of the adapter 6 in the cover 18, thus assuring the locking in translation of the adapter 6 relative to said cover 18 of the arm.

As shown in [FIG. 4], the cover 18 comprises at least the blocking openings 90 of the blocking units 56 of the adapter 6. More specifically, the first lateral flank 40a of the cover 18 comprises a first blocking opening, not shown, which can receive the first blocking unit of the first tongue of the adapter, and the second lateral flank 40b of the cover comprises a second blocking opening 90 of the second blocking unit 56 of the second tongue 48b of the adapter 6. Each of the blocking openings 90 of the cover 18 is open on each of the free edges 82 of the lateral flanks 40 of the cover 18. In addition, the blocking openings 90 and the blocking units 56 have complementarity of form, such that they cooperate in order to assure the securing of the adapter 6 relative to the cover 18 of the wiper arm, at least in the direction Land in the direction V.

A method for assembly of the adapter 6 in the cover 18 will now be described with reference to [FIG. 4]. It should be considered that the adapter 6 is designed to be accommodated in a receptacle 92 for receipt of the cover, delimited by the lateral flanks 40 and the upper flank 42, with the said receipt receptacle 92 being open longitudinally at least at the longitudinal end of the cover which bears the apertures 38.

The method comprises a first step, during which the rear end 32 of the adapter 6 is positioned facing a longitudinal opening of the receptacle 92 for receipt of the cover 18. During a second step of the method, a movement of longitudinal translation of the adapter 6 towards the receptacle 92 for receipt of the cover 18 is carried out. More particularly, during the second step of the method, it is assured that each of the guide surfaces 80 of each of the elements 76 for guiding of the tongues 48 slides along each of the free edges 82 of each of the lateral flanks 40 of the cover 18. This therefore permits precise and controlled translation of the adapter 6 in the receptacle 92 for receipt of the cover 18. These technical means increase the ergonomics of assembly of the wiper on its arm.

In addition, it is understood that, during the longitudinal translation of the adapter 6 in the receptacle 92 for receipt of the cover 18, each of the outer faces 62 of the lateral walls 20 of the adapter 6 slides along an inner face 94 of each of the lateral flanks 40 of the cover 18, with the inner faces 94 facing the receipt receptacle 92. Optionally, the upper wall 22 of the adapter 6 slides longitudinally along an inner face of the upper flank 42 of the cover 18.

By this means, each of the tongues 48 is deformed transversely towards the lateral walls 20, such that the blocking units 56 approach said lateral walls 20. It is thus understood that this deformation is facilitated at least by the first lateral chamfers 86 of the blocking units 56, positioned at the longitudinal ends of said blocking units 56 which are furthest from the head 34.

The longitudinal translation of the adapter 6 in the receptacle 92 for receipt of the cover 18 is then continued until each of the blocking units 56 of each of the tongues 48 is accommodated in the blocking openings 90 of the lateral flanks 40 of the cover 18, as previously described. It is thus understood that, when the blocking units 56 are accommodated in the blocking openings 90, the tongues 48 return to their initial state, with the second lateral chamfers of the blocking units 56 formed at their longitudinal ends which are closest to the head 34 participating in accompanying the passage of the tongues 48 from their deformed state to their initial state. This therefore prevents sudden transitions from a deformed state to an initial state of the tongues 48, which could damage the tongues by excessive resilient return.

Simultaneously with the accommodation of the blocking units 56 in the blocking openings, each of the studs 36 of the head 34 is accommodated in each of the apertures 38 of the lateral flanks 40 of the cover 18. This therefore assures a suitable position of the adapter 6 in the receptacle 92 for receipt of the cover 18 of the wiper arm.

It is thus understood that it is necessary to separate the adapter 6 from the cover 18 of the wiper arm, with pressure on the areas 74 for grasping of the tongues 48 towards the lateral walls 20 of the adapter 6, then longitudinal translation in the direction which is the inverse of that of insertion, being sufficient to separate the adapter and cover.

It is also understood that both during the insertion of the adapter 6 in the receptacle 92 for receipt of the cover 18 and during their separation, the limitation units 60 make it possible to accompany and limit the deformation of the resiliently deformable tongues 48, thus limiting the risks of breakage of their material, in particular at the hinge areas 58. This therefore increases the hold of the adapter 6 in the cover 18 of the wiper arm during the use of the wiping system.

The invention as it has just been described is not, however, limited to the means and configurations exclusively described and illustrated, but also applies to all equivalent means or configurations and to any combination of such means or configurations.

1. An adapter for securing a wiper on an arm of a wiping system, the adapter comprising:
a longitudinal direction, and is configured to be fitted such as to pivot around an axis of rotation on a connector of the wiper,
at least two lateral walls,
wherein the lateral walls are opposite one another in a transverse direction of the adapter, and are connected to one another by an upper wall, such that the lateral walls and the upper wall form a body of the adapter which delimits at least partly a receipt space for the connector,
wherein the upper wall being is extended longitudinally by at least one lug, from which there extends at least one resiliently deformable tongue supporting a blocking unit,
wherein the blocking unit is designed to lock the adapter relative to the arm; and
at least one unit for limitation of the displacement of the resiliently deformable tongue,
wherein the limitation unit extends between the body of the adapter and the blocking unit.

2. The adapter as claimed in claim 1,
wherein the at least one limitation unit projects from an outer face of the lateral wall of the body.

3. The adapter as claimed in claim 2,
wherein the limitation unit projects from the lateral wall at the level of the upper wall.

4. The adapter as claimed in claim 2,
wherein the at least one limitation unit projects from the lateral wall while going away from the upper wall.

5. The adapter as claimed in claim 2,
wherein the at least one limitation unit extends in a direction is inscribed.

6. The adapter as claimed in claim 1,
wherein the limitation unit comprises at least two parts which form a non-zero angle relative to one another.

7. The adapter as claimed in claim 1,
wherein the limitation unit comprises at least one securing end which is integral with the body of the adapter, and one connection end which is integral with the tongue.

8. The adapter as claimed in claim 1,
wherein the tongue comprises at least one grasping area positioned on the blocking unit, with the area for grasping of the tongue comprising at least one guide element which extends in the longitudinal direction of the adapter.

9. The adapter as claimed in claim 8,
wherein the guide element comprises a guide surface which is configured to translate along a cover of the arm of the wiping system.

10. A wiper comprising:
at least one wiper blade;
a connector; and
an adapter as claimed in claim 1,
wherein the blade is supported directly or indirectly by the connector, and
wherein the adapter is fitted such as to pivot relative to the connector.
